(19) United States
(12) Patent Application Publication
(10) Pub. No.: US 2018/0097436 A1
(43) Pub. Date: Apr. 5, 2018

(54) COOL ACTUATOR

(71) Applicant: RAYMOND JAMES WALSH, DALLAS, TX (US)

(72) Inventor: RAYMOND JAMES WALSH, DALLAS, TX (US)

(21) Appl. No.: 15/723,036

(22) Filed: Oct. 2, 2017

Related U.S. Application Data
(60) Provisional application No. 62/403,079, filed on Oct. 1, 2016.

(51) Int. Cl. H02K 41/035; H02K 9/08; H02K 11/21; H02K 11/30

(52) U.S. Cl. CPC H02K 41/0356; H02K 9/08; H02K 41/0358; H02K 11/30; H02K 11/21

(57) ABSTRACT

What is disclosed is an actuator that can include a linear or cylindrical actuator. The actuator utilizes two or more groups of magnets, at least one magnet group traveling inside the coil assembly magnetically coupled to at least one magnet group traveling parallel and outside the coil assembly. Contiguous leading and trailing coils are sequentially activated in tandem with the advancing magnet groups in order to continuously optimize electromotive force.

### CROSS-REFERENCE TO RELATED APPLICATIONS

This application claims the benefit of U.S. Provisional Application No. 62/403,079 filed Oct. 1, 2016, the disclosure of which is incorporated by reference.

### TECHNICAL FIELD

This application relates to the technical field motors and actuators, and more particularly to permanent magnet motors.

### BACKGROUND

A permanent magnet motor/actuator converts electrical energy into work via an interaction between the permanent magnetic field of the magnet and the variable field generated by electricity passing through a coil of wire. Permanent magnet field strength is limited by material and neodymium produces the strongest magnets. The magnetic field strength of the coil wire is determined by electrical current, which is also limited by material. The electrical resistance of copper is low, making this ideal coil material.

Electrical resistance introduces an inherent inefficiency, converting electrical energy into heat. Heat in turn increases electrical resistance and further decreases efficiency.

Friction between components generates a second source of heat. Regardless of the source of heat, it follows that optimal magnetic field generation is served by optimal heat dissipation. In a typical permanent magnet motor, the proximity of the electrical coils to the frictional components compounds the problem of heat generation ultimately limiting the magnitude of magnetic field generation by the electrical coils.

A second consideration relates to rotor/stator geometry. Optimal electromotive force is achieved when the axis of a motor coil aligns with the permanent magnet field. A typical permanent magnet motor employs a shaft with rotating coils surrounded by magnets, or a shaft with rotating magnets surrounded by coils. Either way, during motor rotation the field/coil angle, that is the angle between the coil axis and the permanent magnet field, never aligns but rather varies between zero and 90 degrees. The result is that an incomplete or inefficient interaction between coil and permanent magnet. It is for this reason that most permanent magnet motors perform best at high RPM's and tend to bog down when heavy torque is required.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The cool actuator, which may be coupled to crankshaft or flywheel to form a motor, allows for optimal heat dissipation as the frictional components are not in contact or proximity to the electrical coils. The physical separation between coils and frictional components allows for optimal cooling of the coils by allow the free flow of cooling fluid around the coils. This fluid may be air. The coils may be enclosed in a sealed jacket for the circulation of coolant, thus minimizing heat and resistance, and thereby optimizing magnetic field generation.

The disclosed inventive concepts utilize placing a magnet group inside the coil so the coil axis always aligns with the permanent magnet field. This magnet group travels between two adjacent and opposing coils so that the two coils act synergistically to urge the magnet group in the same direction, one coil pushing while the other pulls.

What is further disclosed is coupling the magnet group inside the coils with a second magnet group outside the coils. The magnet groups couple so as to complete a magnetic circuit with greater net magnetic flux. Depending on how close the magnet groups are to one another, this coupling increases the magnetic field strength or flux of the permanent magnet group inside the coils up to a factor of two. Greater magnetic flux in the permanent magnets produces a greater electromotive force from the coils. In other words, coupling the magnet group within the coil to a magnet group outside the coil effectively augments the net permanent magnet flux experienced by the coil, resulting in the generation of greater net electromotive force.

Another improvement of the Cool Actuator over the prior art is the way in which the coils are energized so as to create a continuously optimal force. As the magnet group travels within the tunnel produced by adjacent coils, the electromotive force on the magnet group is not uniform. The force is at a maximum when the longitudinal midpoint of the magnet group straddles the border between two adjacent opposing coils groups

One embodiment optimizes electromotive force by sensing the position of the moving magnet group and changing the position of the border between the two coils. This is achieved by subdividing the two coils each into smaller incremental coils. As the magnet group advances in one direction, the incremental coils trailing behind, hereafter the trailing coils, are all energized so as to push the magnet group in the desired direction while all the coils in front of the magnet group, hereafter the leading coils, are energized to pull the magnet group in the same direction. In other words, as the magnet group advances, incremental coils immediately in front of the magnet group will transition and join the trailing coils. When this happens, current through the incremental coil reverses direction and the incremental coil transitions from pulling to pushing. In this way, the border between the leading and trailing coils advances continuously to line up with the longitudinal midpoint of the magnet group thus maintaining maximal electromotive force on the magnet group.

Further disclosed is the concept of varying the electric flow to the coils on the fly to maintain optimal force on the magnet. In other words, as a magnet assembly travels down a long track of coils, the coils in proximity to the magnet assembly are switched on, and those coils far from the magnet assembly, either in front or behind, are switched off. This variable coil actuation may be combined with the idea of augmenting the magnet group inside the coil by coupling with a magnet group outside the coils. The result is an effective and efficient transfer of electrical energy into mechanical work.

What is disclosed is an actuator, including linear and/or reciprocating. The actuator includes a plurality of magnet groups. It is important to note that the term “magnet group” herein means one or more magnets, and may include a ferromagnetic iron or steel focusing elements on either end of the magnet groups. The actuator also includes a coil assembly made up of a plurality of contiguous coils.

One embodiment has two electric coils configured for providing an antiparallel or opposing magnetic field generated by passing current in the opposite direction through each. The coils are next to each other, immediately adjacent (i.e., contiguous), or separated by a separator and/or sensor, and are configured for opposite current flow. There is a continuous tunnel through which an inner permanent magnet group travels. Coupled to this inner magnet group there is a second outer permanent magnet group mounted parallel to the first and outside the coil assembly. The two magnet groups are attached by a mount or scaffolding which serves the dual purpose of allowing the magnet groups to travel together while maintaining an optimal gap distance between the magnet groups. The wall of the coil lies within the gap between the two magnet groups. The magnetic coupling between the magnet groups completes a magnetic circuit, effectively increasing the total permanent magnetic flux.

In one preferred embodiment, the actuator can include a second coil assembly, parallel to the first, within which the second magnet group travels, so that both magnet groups have their own dedicated coil assembly. The second coil assembly is configured in similar fashion to the first electric coil assembly, providing a continuous tunnel within which the second magnet group may travel. The first coil assembly tunnel and the second coil assembly tunnel are parallel.

In another preferred embodiment, the elements of the actuator can be cylindrical. In this embodiment, the outer magnet group forms a hollow cylinder. The coil assembly is likewise cylindrical but having a smaller diameter so that the outer magnet group surrounds the coil assembly. The inner magnet group, also cylindrical, has a smaller diameter sufficient to fit within the coil assembly. The outside magnet group has a magnetic orientation antiparallel to the inner magnet group. Opposite poles couple at either end so as to complete a magnetic circuit. Each magnet may be fitted with a ferromagnetic iron or steel focusing element on either end of each magnet group in order to focus magnetic flux and aid in magnetic coupling. A predetermined gap separates the two magnet groups, and the coil assembly resides within this gap.

The actuator may include a sensor for detecting the position of the magnets relative to the coils. The sensor feeds input to the controller in order to energize the coils based on the location the magnet groups relative to the coil assembly. Experimentation has determined that optimal electromotive force between coils and magnets occurs when the midpoint of the magnets aligns with midpoint of the coils. The midpoint of the coils is the border between those coils generating magnetic flux in one direction and those generating magnetic flux in the opposite direction.

The process is dynamic, and the initial electromotive force will urge the magnets to move away from optimal alignment relative to the coils. The sensor detects this change, sends the new positional information to a controller which then reconfigures electrical output to the coil assembly, reversing current where necessary, to re-align the coil midpoint to the midpoint of the magnet assembly. This, in turn, causes the magnet assembly to again move away from optimal alignment, and the process repeats itself. The result is dynamic adjustment of coil actuation in order to maintain continuous optimal force between magnets and coils as the magnets move relative to the coils.

The objective is to continuously optimize the pushing and pulling of the magnets by the electric coils to maintain the continuous optimal efficiency of the actuator. Sensors can be located in proximity to none, one, more than one, or all of the electric coils of each assembly. The actuator can use one or more controller(s) or processor(s) configured to reverse the electric flow the coils in order to increase the efficiency of the actuator. The electric coils are preferably mounted on a scaffolding.

The magnet groups are generally attached to a support or mount. The support or mount between separate mounting groups can be attached or detached to operate one or more mechanisms for doing work, such as an arm, flywheel, crankshaft or other known or future developed mechanism for doing work.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates an embodiment of an actuator comprising one coil group with two magnet groups.

FIG. 2 illustrates an embodiment of the actuator of FIG. 1 in which the coil group has been subdivided.

FIG. 3a illustrates a cross sectional view of FIG. 2 depicting the sequential actuation of the coil group of FIG. 2 with the magnet group in a first position.

FIG. 3b illustrates a cross sectional view of FIG. 2 depicting the sequential actuation of the coil group of FIG. 2 with the magnet group in a second position.

FIG. 3c illustrates a cross sectional view of FIG. 2 depicting the sequential actuation of the coil group of FIG. 2 with the magnet group in a third position.

FIG. 4 illustrates an embodiment of an actuator comprising two coil groups with two magnet groups.

FIG. 5 illustrates a cross sectional view of the orientation of an embodiment having one internal and two external magnet groups associated with one coil assembly.

FIG. 6a illustrates a perspective view of a cylindrical embodiment of an actuator according to the inventive concepts disclosed herein.

FIG. 6b illustrates a side view of a cylindrical embodiment of the actuator of FIG. 6a.

FIG. 7a illustrates the embodiments of FIGS. 6a and 6b depicting sequential actuation of the coil assembly with the coil assembly in a first position.

FIG. 7b illustrates a cross sectional of the embodiments of FIGS. 6a and 6b depicting sequential actuation of the coil assembly with the coil assembly in a second position.

FIG. 7c illustrates a cross sectional of the embodiments of FIGS. 6a and 6b depicting sequential actuation of the coil assembly with the coil assembly in a third position.

### DETAILED DESCRIPTION OF THE DRAWINGS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

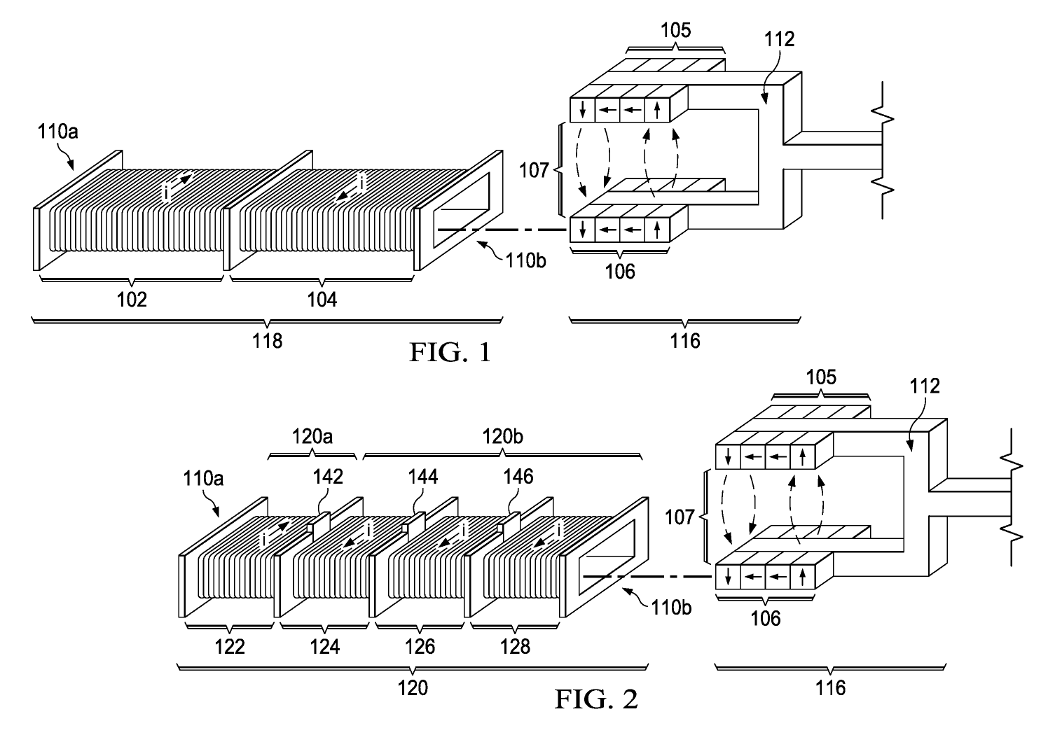

FIG. 1 illustrates a linear actuator having a coil assembly 118 and a magnet assembly 116. The linear actuator can utilize either the magnet assembly or the coil assembly in a fixed position with the remaining magnet assembly or coil assembly operating as a piston moving in and out in response to electromotive force generated between energized coil assembly 118 comprising coils 102 and 104, and magnet assembly 116 comprising coupled magnet groups 105 and 106. These coupled magnet groups create a gap 107 through which flows magnetic flux designated by the dashed arrows. Magnet group 106 travels within coil assembly 118, and so would be classified as an inner magnet group. Magnet group 105 travels outside coil assembly 118, and so would be classified as an outer magnet group. Activation of the coils creates an electric current in the direction indicated by the “i” and arrow. Thus coil 102 and coil 104 have opposite current flow, and generate opposite magnetic flux, and thus one pushes while the other pulls. Coils 102 and 104 thus exert a simultaneous and synergistic electromotive force on magnet assembly 116.

Magnet groups 105, 106 are mounted on magnet support arm 112. Magnet support arm 112 can then be connected to any device or operative piston to produce linear actuation. Experimentation has shown that including the second magnet group 105 increases magnetic flux within the circuit, with a resultant increase in the electromotive force by a factor of 1.3× to 1.7× depending largely on the magnitude of gap 107.

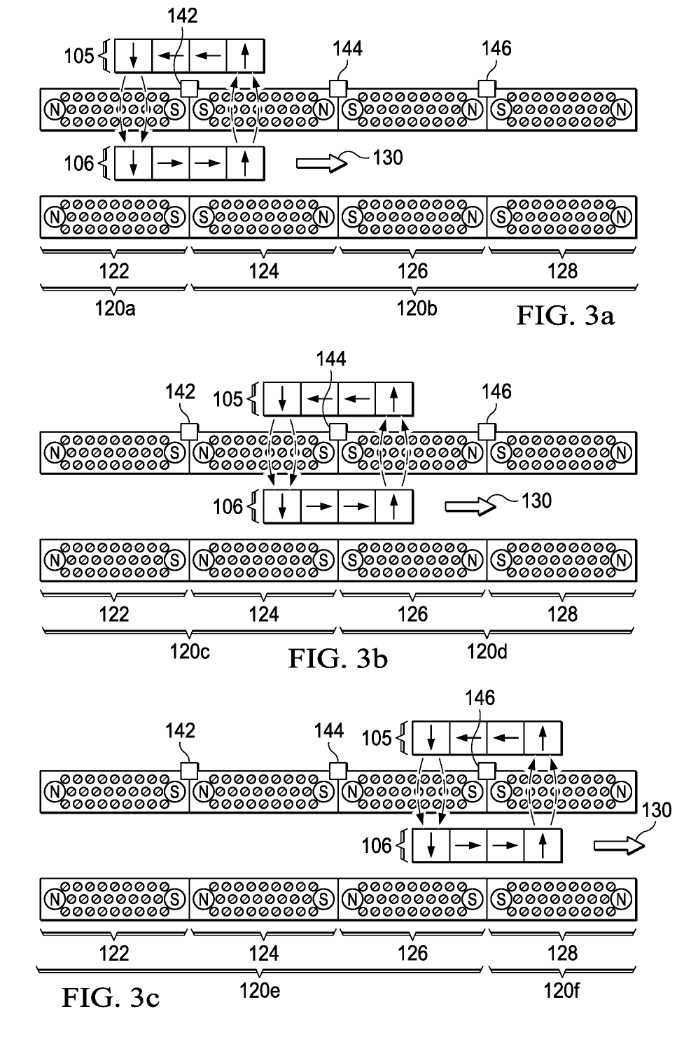

FIG. 2 illustrates the magnet assembly 116 of FIG. 1 in association with an alternative subdivided embodiment of the coil assembly. The subdivided coil assembly 120 of FIG. 2 includes four different coils subdivisions 122, 124, 126, 128. Sensors 142, 144, 146 sense the position of magnet assembly 116 as it moves relative to coil assembly 120. The subdivided coils may be energized individually in a predetermined direction in order to continuously optimize the electromotive force between coil assembly 120 and magnet assembly 116. Depending on the direction of current, a subdivided coil may in the group of trailing coils 120a, or in the group of leading coils 120b.

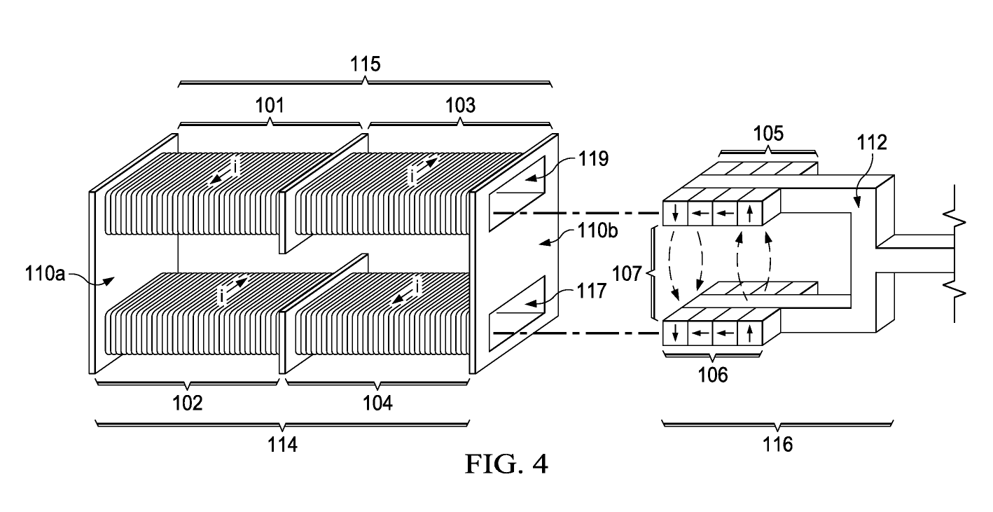

FIG. 3a represents a sectional view through the coil and magnet assemblies of FIG. 2. Magnet group 106 is magnetically coupled to magnet group 105 so as to complete a magnetic circuit. Magnet group 106 in FIG. 3a lies to the far left side of coil assembly 120, as sensed by position sensor 142. Each coil 122, 124, 126, and 128 has an “N” on one end and an “S” on the other designating the magnetic field of the coil. The magnetic field orientation each of coils 122, 124, 126, and 128 is determined by the direction of the current flowing through each coil.

The direction of current through coil 122 generates a magnetic field that exerts a push force on magnet group 106, causing magnet group 106 to move in the direction designated by arrow 130. Thus coil 122 trails behind magnet 106 and falls within the group of trailing coils 120a.

Current through the three other coils 124, 126, and 128 is opposite that through coil 122. The resultant magnetic field direction is also opposite, exerting a pull force on magnet group 106. This also causes magnet group 106 to move in the direction designated by arrow 130. Coils 124, 126, and 128 lie ahead of magnet group 106 and therefore fall within leading coil group 120b. The net result is a synergistic urging of magnet 106 in the rightward direction 130.

In FIG. 3b, position sensor 144 detects that magnet group 106, coupled to magnet group 105, lies within the center of the coil assembly 120. The controller reverses the current to 124, and thus 124 transitions from pulling 106 to pushing. Coil 122 and 124 are now included in trailing coil group 120c while 126 and 128 fall within leading coil group 120d. In fact, both 122 and 124 push on 106 while 126 and 128 continue to pull with the result that all 4 coils continue to urge 106 in the direction indicated by arrow 130. As such, magnet assembly 106 continues to be urged in rightward direction 130.

In FIG. 3c, position sensor 146 detects that magnet group 106, coupled to magnet group 105, lies to the right of the coil assembly 120. The controller reverses the current to 126, and thus 126 transitions from pulling 106 to pushing. Coil 122, 124, and 126 are now included in trailing coil group 120e, while 128 falls within leading coil group 120f. Now coils 122, 124, and 126 push on 106 while coil 128 continues to pull with the result that all 4 coils continue to urge 106 in the rightward direction indicated by arrow 130. As such, magnet assembly 106 continues to be urged in rightward direction 130.

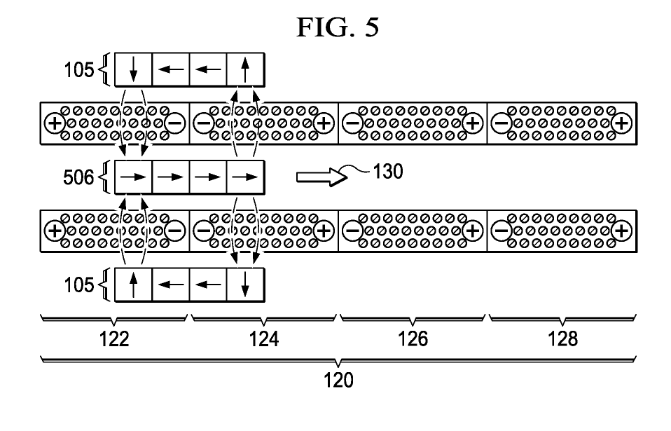

FIG. 4 illustrates a preferred embodiment that is substantially similar to the embodiment shown in FIG. 1, with the addition of coil assembly 115 comprising coils 101 and 103. Magnet assembly 116 comprises magnet groups 105 and 106 are both magnetically coupled across gap 107 and fixably attached by support arm 112. Magnet support arm 112 can then be connected to any device for transfer of mechanical energy. Rear scaffolding 110a and front scaffolding 110b fixably attach coil assembly 115 to coil assembly 116. Magnet group 105 travels within tunnel 119 of coil assembly 115, while magnet group 106 travels within tunnel 117 of coil assembly 114. A defining feature of this embodiment is that both magnet groups 105 and 106 would be classified as inner magnet groups as each travels within its own plurality of coils. Thus, in this embodiment there are no outer magnet groups.

As mentioned previously, experimentation has shown that including the second magnet group 105 has been found to increase the electromotive force generated by a factor of 1.3× to 1.7× depending largely on the magnitude of gap 107. Including a second plurality of coils, namely coil 101 and coil 103, within which travels magnet group 105, further doubles the effective pull force of this embodiment of the Cool Actuator.

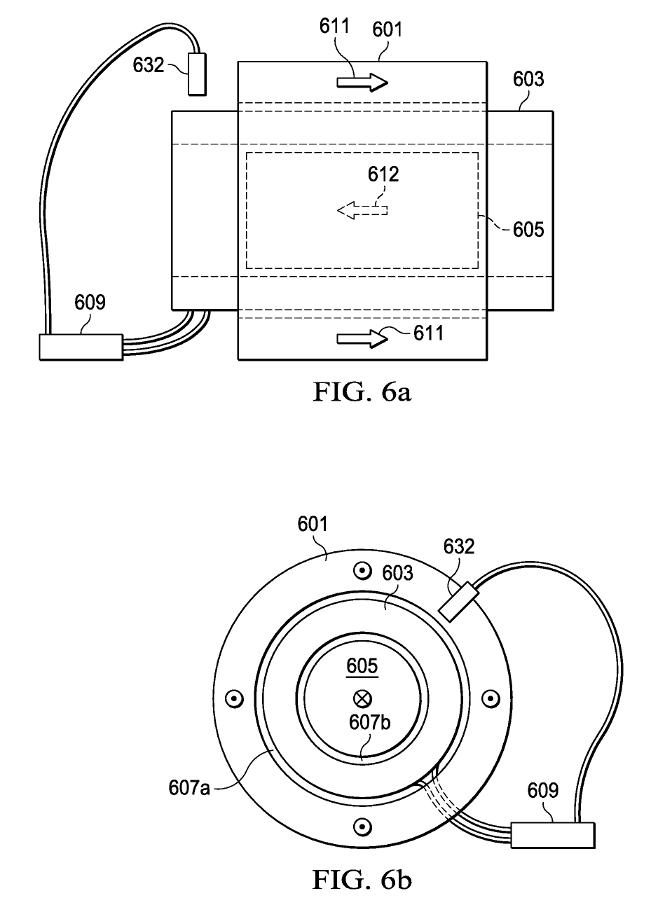

FIG. 5 illustrates a preferred embodiment comprising similar elements of the embodiment of FIG. 2. This embodiment illustrates that a plurality of external magnet groups 105 may be displaced around coil assembly 120 having a single inner magnet group 506. Actuation of coil assembly 120 urges inner magnet 506 and associated outer magnets 105 to move in rightward direction 130.

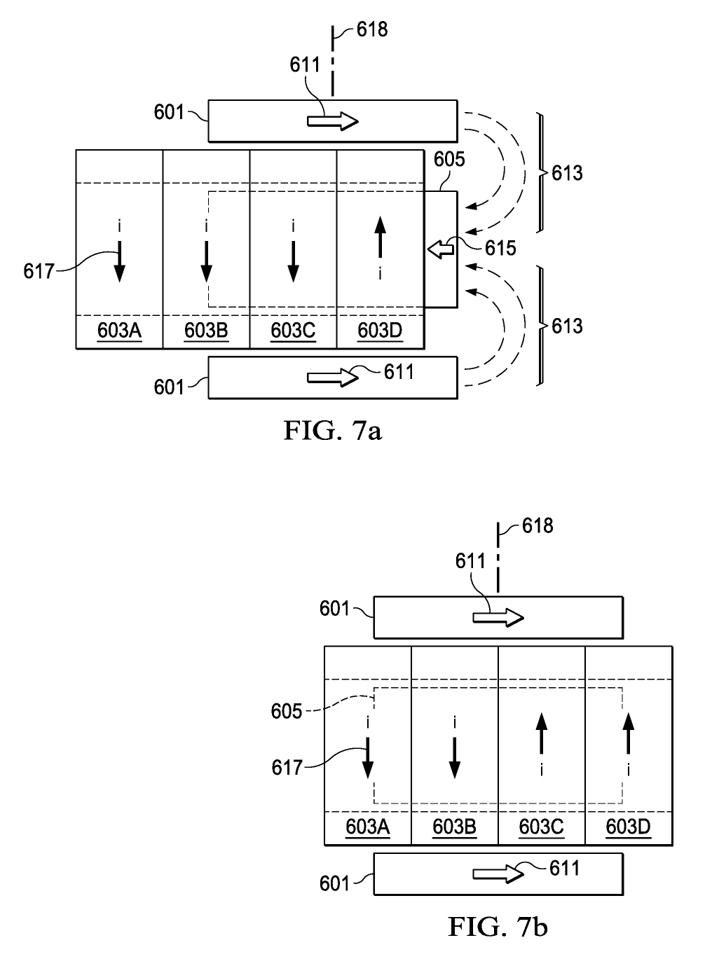

FIG. 6a illustrates another preferred embodiment in which the Cool Actuator takes on cylindrical form. It is a logical extension of the embodiment described in FIG. 1, having a single outer magnet group 105, with the added specification that outer magnet group 601 of the cylindrical Cool Actuator completely surrounds coil assembly 603 and inner magnet group 605.

This embodiment comprises a cylindrical inner magnet 605 within an outer ring magnet 601 having a larger radius. Magnetic orientation arrow 611 of the outer ring magnet 601 is anti-parallel, or in opposite direction, to the magnetic orientation arrow 612 of cylinder magnet 605. The length of magnet 601 is substantially the same length as magnet 605, thus north and south poles are proximate on either end of the magnet assembly enabling the two magnets to couple on both ends. In the gap between the two magnets resides cylindrical coil assembly 603, which travels relative to the coupled magnets 601 and 605 when energized by controller 609 which receives input from position sensor 632.

In one embodiment, coil 603 comprises a coil assembly of two adjacent coils energized opposite one another. The two coils thus produce opposite magnetic fields, one pulling on the magnets and one pushing. The two coils need not be the same size. Experimentation has shown that the electromotive force is greatest when the midpoint between the two opposite coil groups intersects the longitudinal midpoint of the coupled magnets. At this midpoint, one coil group effectively pulls the magnet assembly while the other effectively pushes, and the two coil groups act synergistically to move coil 603 in the same direction relative to the coupled magnets.

In another embodiment, coil 603 comprises a plurality or assembly of adjacent coils. As coil assembly 603 moves relative to the magnets, controller 609 energizes the coils in two groups, a pushing group and a pulling group. Those coils on one side of the magnets are energized to pull on the magnets, while the coils on the other side of the magnets are energized to push away from the magnets. As coil assembly 603 moves through the magnets, individual coils must transition from pulling to pushing as they pass through the magnetic midpoint. This is controlled by controller 609 using position sensors well known to those skilled in the art.

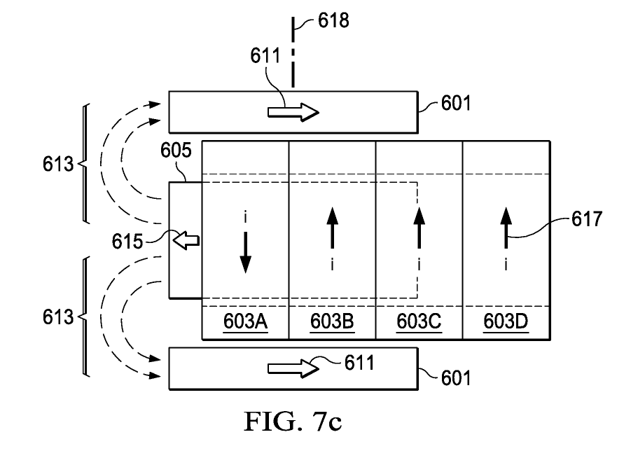

FIGS. 7a, 7b, and 7c illustrate the movement of coil 603 from left to right as a result of electromotive forces generated by the coil subdivisions 603A, 603B, 603C, 603D. The magnet assembly comprises ring magnet 601 magnetically coupled to cylinder magnet 605. The longitudinal midpoint of the magnet assembly is indicated by line 618, and corresponds with the border between leading and trailing coils. Magnetic flux lines are shown as 613. Arrow 611 indicates the magnetic field orientation of magnet 601, and arrow 615 the magnetic field orientation of magnet 605.

In this series of figures, coil 603 has been subdivided into four smaller coils labeled 603A, 603B, 603C, and 603D. The direction of current is indicated by 617. Notice that in FIG. 7a, coils 603A, 603B, and 603C line to the left of midline 618. Notice also that current 617 for these three coils is in the same direction, whereas the current through 603D, which lies to the right of the midline, is in the opposite direction. The result is that the three coils to the left of the midline pull on the magnet assembly while 603D to the right of midline pushes. As a result of the coil positions relative to the midline 618, and the individual directions of electrical currents 617, the effect is synergistic inducing an electromotive force on the coil in the left to right direction relative to the magnet assembly.

In FIG. 7b, the coil assembly has shifted to the right. Now coil 603C lies to the right of the midline. Sensing this new position, controller 609 (not pictured) reverses the direction of current through coil 603C, which transitions from pulling on the back assembly to pushing away from it. As in FIG. 7a, the position of the coils relative to the magnet midpoint 618 and the direction of current flowing through each coil results in movement of the coil from left to right relative to the magnet assembly.

The coil in FIG. 7c advances to the right by similar mechanism. In FIG. 7c, coil 603B finds itself to the right of the midline. Again, the controller 609 senses this position and reverses the current.

As this is an oscillating actuator, so when coil 603A advances past the midline 618, controller 609 senses this position, reversing the current through all of the coils and the process proceeds in reverse, now inducing coil 603 to move incrementally from right to left.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An actuator, said actuator comprising:
a first magnet group;
a first electric coil assembly, wherein said first electric coil assembly comprises a first electric coil and a second electric coil, wherein said first electric coil and said second electric coil are configured for providing a variable magnetic field generated by electricity passing through said coils, wherein said first electric coil and said second electric coil are adjacent and are configured for opposite current flow, wherein said first electric coil assembly is configured to provide a continuous first tunnel in which first magnet group is configured to travel;
a second magnet group, wherein said first magnet group and said second magnet group are magnetically coupled so as to complete a magnetic circuit, wherein said first magnet group and said second magnet group are in a generally parallel orientation having a gap between said first magnet group and said second magnet group, wherein said first magnetic group said second magnetic group are fixably attached such that said first magnet group and said second magnet group configured to travel in parallel as said first magnet group travels in said first tunnel.

2. The actuator of claim 1, wherein said actuator comprises a second electric coil assembly, wherein said second electric coil group comprises a first electric coil and a second electric coil, wherein said first electric coil and said second electric coil of said second electric coil assembly are adjacent and are configured for opposite current flow, wherein said second electric coil assembly is configured to provide a continuous second tunnel through which said second magnet group is configured to travel.

3. The actuator of claim 1, wherein said actuator comprises a cylindrical actuator, wherein said second magnet group is configured as a hollow cylinder so as to surround said first electric coil assembly, and said coil assembly is configured as a hollow cylinder having a smaller radius than said second magnet group, and said first magnet group is configured as a cylinder having a smaller radius than said coil assembly.

4. The actuator of claim 1, wherein said actuator comprises a sensor for detecting the position of said first magnet group in relation to said first electric coil of said first electric coil assembly, and a controller operationally connected to said sensor, the controller configured to reverse the electric direction in said first electric coil and said second electric coil of said first electric coil assembly based on the position of said first magnet assembly in relation to said first electric coil assembly.

5. The actuator of claim 1, wherein said first electric coil assembly further comprises a third electric coil and a fourth electric coil assembly, wherein said first electric coil assembly comprises a sensor for sensing a position of said first magnet assembly in relation to said first electric coil assembly; and
wherein said actuator comprises a controller configured to reverse the electric current to said first coil, said second coil, said third coil, and said fourth coil in response to the location of said first magnet assembly in relation to said first electric coil assembly.

6. The actuator of claim 1, wherein said electric coils are mounted on a scaffolding, wherein said scaffolding forms a tunnel around which said electric coils are wrapped.

7. The actuator of claim 1, wherein said first magnet group and said second magnet group are connected to a support, wherein said support is connected to a mechanism for the purpose of doing work.

8. The actuator of claim 5, wherein said actuator further comprises a plurality of sensors, positioned between adjacent electric coils, wherein said sensors are configured to sense a position of said first magnet assembly in relation to said first electric coil assembly.

9. The actuator of claim 2, wherein said actuator comprises a sensor for detecting the position of said second magnet group in relation to said second electric coil assembly, wherein said sensor is configured to reverse the electric flow in said first electric coil and said second electric coil of said second electric coil assembly based on the location of said first magnet group in relation to said first electric coil of said first electric coil assembly.

10. A linear actuator comprising:
a first magnet assembly comprising a first magnet group and a second magnet group, said magnet assembly configured so that the first magnet group magnetically couples to the second magnet group;
a first coil assembly comprising a plurality of contiguous coils configured to produce a first tunnel;
one or more position sensors fixably attached to said first coil assembly and configured to detect the position of the magnet assembly relative to the first coil assembly;
a controller configured to receive input from said position sensors, and configured to actuate said first coil assembly so as to urge the first magnet assembly in a predetermined direction, wherein the first magnet group moves within the first tunnel and the second magnet group moves outside the first coil assembly.

11. The linear actuator of claim 10 in which the one or more position sensors are fixably attached to said first magnet assembly.

12. The linear actuator of claim 10 further comprising a second coil assembly fixably attached to the first coil assembly, said second coil assembly comprising a plurality of contiguous coils configured to produce a second tunnel parallel to the first tunnel; and said controller is further configured to actuate the coils of the second coil assembly so as to urge the second magnet group through the second tunnel in a predetermined direction parallel to the first magnet group.

13. The linear actuator of claim 10 wherein the magnet assembly further comprises a third magnet group fixably attached to the first magnet group, configured so as to maintain a gap between the first magnet group and the third magnet group, so that the third magnet group magnetically couples with the first magnet group, wherein said third magnet group travels outside the first coil assembly.

14. The linear actuator of claim 10 in which the second magnet group is a hollow cylinder that surrounds the first coil assembly.

15. The linear actuator of claim 10 in which the first coil assembly comprises one or more leading coils and one or more trailing coils, wherein the border between said leading and said trailing coils is substantially proximal to the longitudinal midpoint of the coil assembly, and the controller is configured to actuate said trailing coils so as to urge the magnet assembly in a predetermined direction, and the controller is configured to actuate said leading coils so as to urge said magnet assembly in the same predetermined direction.
